(19) United States
(12) Patent Application Publication
(10) Pub. No.: US 2019/0118807 A1
(43) Pub. Date: Apr. 25, 2019

(54) VEHICLE CONTROL APPARATUS AND VEHICLE CONTROL METHOD

(71) Applicant: DENSO CORPORATION, Kariya-city, Aichi-pref. (JP)

(72) Inventor: Ryo TAKAKI, Kariya-city, Aichi-pref. (JP)

(21) Appl. No.: 16/092,600

(22) PCT Filed: Apr. 5, 2017
(86) PCT No.: PCT/JP2017/014214

§ 371 Date: Oct. 10, 2018

(30) Foreign Application Priority Data
Apr. 11, 2016 (JP) 2016-079120

(51) Int. Cl. B60W 30/095; B60W 30/09; B60W 40/105; G08G 1/16

(52) U.S. Cl. CPC B60W 30/0953; B60W 30/09; B60W 2550/302; G08G 1/166; B60W 2550/306; B60W 40/105

(57) ABSTRACT

A driving assistance ECU includes: a movement path calculation section which calculates a movement path of an object based on a position history of the object around an own vehicle; a collision position calculation section which calculates, based on the calculated movement path, a lateral collision position that is a position of the object in a vehicle width direction in an assumed state where the distance between the object and the own vehicle is zero; and a correction section which corrects the lateral collision position so that when the movement path has a small slope with reference to an own vehicle traveling direction, the lateral collision position is closer to the object in the vehicle width direction than when the slope is large.

### CROSS REFERENCE TO RELATED APPLICATIONS

The present application is based on and claims the benefit of priority from earlier Japanese Patent Application No. 2016-079120 filed on Apr. 11, 2016, the description of which is incorporated herein by reference.

### TECHNICAL FIELD

The present disclosure relates to a vehicle control apparatus that determines a probability of a collision between a vehicle and an object, and a vehicle control method.

### BACKGROUND ART

A vehicle control apparatus which obtains a position of an object around an own vehicle and determines, on the basis of the obtained position, a probability of a collision between the object and the own vehicle is known. For example, the vehicle control apparatus disclosed in Patent Literature 1 calculates, on the basis of a position of an object obtained by a radar device, a movement direction vector indicating a relative movement direction of the object with respect to an own vehicle. Subsequently, the vehicle control apparatus calculates, using the calculated movement direction vector, an estimated position of the object after a predetermined time period, and determines a probability of a collision between the own vehicle and the object using the estimated position that has been calculated.

### CITATION LIST

### Patent Literature

[PTL 1] JP 2007-279892 A

### SUMMARY OF THE INVENTION

If there is an error in an obtained position of an object, a probability of a collision between the object and an own vehicle may be erroneously determined. For example, when a position where the object and the own vehicle may collide with each other is calculated on the basis of a position of the object, the position where the collision is likely to occur is not correctly calculated, whereby a vehicle control apparatus may erroneously determine that the collision with the object is not likely to occur though the collision is actually likely to occur.

The present disclosure has been conceived to solve the aforementioned problem, and has an objective to provide a vehicle control apparatus that properly determines a probability of a collision between a vehicle and an object, and a vehicle control method.

In the present disclosure, the vehicle control apparatus determines a probability of a collision between an own vehicle and an object and controls the own vehicle based on a determination result. The vehicle control apparatus includes: a movement path calculation section which calculates a movement path of the object based on a position history of the object around the own vehicle; a collision position calculation section which calculates, based on the calculated movement path, a lateral collision position that is a position of the object in a vehicle width direction in an assumed state where a distance between the object and the own vehicle is zero; and a correction section which corrects the lateral collision position so that when the movement path has a small slope with reference to an own vehicle traveling direction, the lateral collision position is closer to the object in the vehicle width direction than when the slope is large.

In the case where the slope of the movement path changes due to an error in the position of the object obtained by a detection means such as a radar sensor, when the slope of the movement path is small, a deviation of the lateral collision position in the vehicle width direction increases as the distance between the object and the own vehicle in the own vehicle traveling direction increases. Thus, on the assumption that the lateral collision position is closer to the current position of the object in the vehicle width direction when the slope of the movement path is small than when the slope is large, the calculated lateral collision position is brought closer to the object by correction.

With the aforementioned configuration, when the slope of the movement path is small, the lateral collision position is inhibited from being relatively distant from an object in the vehicle width direction due to an error in the obtained position of the object, and thus a probability of a collision between the object and the own vehicle can be properly determined.

### BRIEF DESCRIPTION OF THE DRAWINGS

The above and other objects, features and advantages of the present disclosure will become clearer from the following detailed description with reference to the accompanying drawings, in which:

FIG. 1 is a configuration diagram of a PCSS;

FIG. 2 illustrates a movement path of an object Ob;

FIG. 3 illustrates a slope θ of a movement direction vector and a deviation amount of a lateral collision position Xpc;

FIG. 4 is a flowchart illustrating a process of calculating a lateral collision position Xpc;

FIG. 5 illustrates a correction coefficient α which is used to correct the lateral collision position Xpc;

FIG. 6 illustrates correction of the lateral collision position Xpc;

FIG. 7 illustrates a correction coefficient α according to a second embodiment;

FIG. 8 is a flowchart illustrating a process according to a third embodiment which is performed in step S16 in FIG. 4; and

FIG. 9 illustrates a value of the correction coefficient a corresponding to the type of the object Ob.

### DESCRIPTION OF THE EMBODIMENTS

Hereinafter, embodiments of a vehicle control apparatus and a vehicle control method will be described with reference to the drawings. Note that the same or equivalent parts throughout the following embodiments share the same reference signs in the drawings, and the same description applies to the parts denoted by the same reference signs.

### First Embodiment

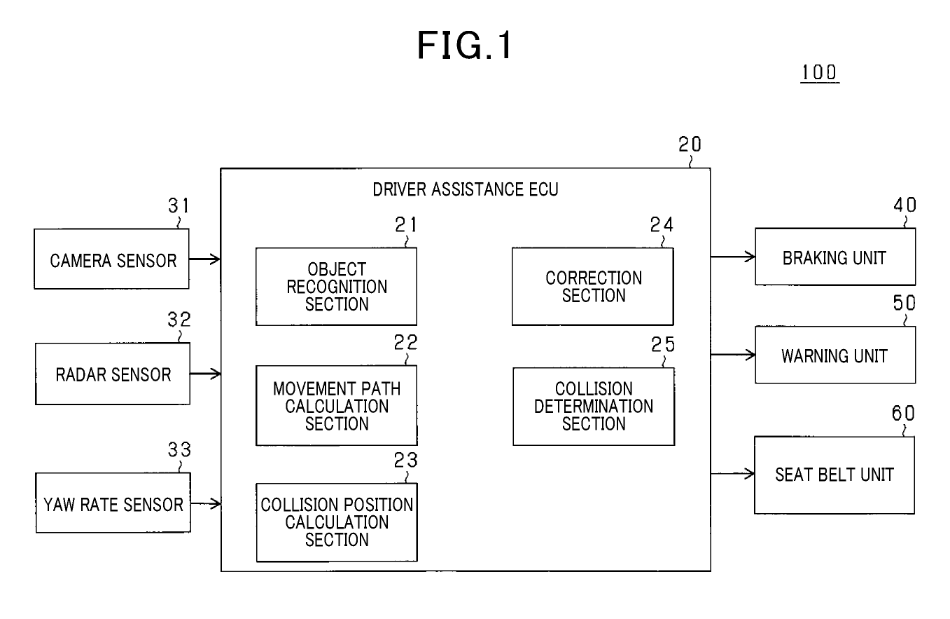

FIG. 1 illustrates a pre-crash safety system (hereinafter, referred to as PCSS) 100 to which a vehicle control apparatus and a vehicle control method are applied. The PCSS 100, which is one example of a vehicle system installed in a vehicle, detects an object located around a vehicle, and when there is a risk of a collision between the detected object and the vehicle, performs an operation of avoiding a collision of the own vehicle with the object or mitigating a damage from the collision. Hereinafter, the vehicle in which the PCSS 100 is installed will be referred to as an own vehicle CS, and the object to be detected will be referred to as an object Ob.

The PCSS 100 shown in FIG. 1 includes various sensors, a driving assistance ECU 20, a braking unit 40, a warning unit 50, and a seat belt unit 60. In the embodiment shown in FIG. 1, the driving assistance ECU 20 functions as the vehicle control apparatus.

The various sensors are connected to the driving assistance ECU 20 and output detection results for the object Ob to the driving assistance ECU 20. In FIG. 1, the various sensors include a camera sensor 31, a radar sensor 32, and a yaw rate sensor 33.

The camera sensor 31 is, for example, a monocular imaging device such as a CCD camera, a CMOS image sensor, or a near-infrared camera. The camera sensor 31 is attached to the center of the vehicle in the vehicle width direction and captures an image of a region spreading over a predetermined angle range ahead of the vehicle. The camera sensor 31 extracts a feature point indicating the presence of the object Ob from the captured image. For example, on the basis of luminance information of the captured image, the camera sensor 31 extracts an edge point and performs a Hough transform on the extracted edge point. In the Hough transform, a point on a straight line on which edge points are continuously arranged or a point at which such straight lines intersect at a right angle with each other is extracted as the feature point.

Furthermore, the camera sensor 31 recognizes a position of the object Ob and the object type from the captured image. In the present embodiment, a pedestrian, a two-wheeled vehicle, and an automobile are recognized as the object type. For example, the camera sensor 31 extracts a region corresponding to the object Ob from the captured image using a motion vector or a histogram of oriented gradients (HOG). Furthermore, the camera sensor 31 performs well-known template matching, edge detection, and the like, on the extracted region to detect the object type and the position of the object. Note that at each control period that is the same as or different from that for the radar sensor 32, the camera sensor 31 determines the object type and transmits the determination result to the driving assistance ECU 20 as type determination information.

The radar sensor 32 transmits electromagnetic waves with directivity, such as millimeter waves and a laser, as transmission waves ahead of the own vehicle and detects a relative position and a direction of the object Ob around the vehicle on the basis of reflected waves corresponding to the transmission waves. The radar sensor 32 is attached to a front part of the own vehicle in such a way that the optical axis of the radar sensor 32 is directed ahead of the vehicle. The relative position is obtained as a position on relative coordinates defined by an X axis corresponding to the vehicle width direction of the own vehicle CS and a Y axis corresponding to a traveling direction of the own vehicle CS where the origin corresponds to the own vehicle CS. In addition, a relative distance Dr between the object Ob and the own vehicle CS can be obtained through calculation of a component of the obtained relative position in an own vehicle traveling direction (Y axis direction). The obtained relative position is input to the driving assistance ECU 20.

The yaw rate sensor 33 detects a turning angular velocity (yaw rate) of the own vehicle CS with reference to a current own vehicle traveling direction.

The braking unit 40 includes a braking mechanism which changes braking force of the own vehicle CS and a braking ECU which controls operation of the braking mechanism. The braking ECU is connected to the driving assistance ECU 20 so as to be able to communicate with each other and controls the braking mechanism under control of the driving assistance ECU 20. The braking mechanism includes a master cylinder; a wheel cylinder which applies braking force to a wheel and an ABS actuator which adjusts pressure (hydraulic) distribution from the master cylinder to the wheel cylinder, for example. The ABS actuator is connected to the braking ECU and adjusts the actuation level of the wheel by adjusting the hydraulic pressure that is applied from the master cylinder to the wheel cylinder under control of this braking ECU.

The warning unit 50 warns a driver of the presence of the object Ob in front of the own vehicle by the control of the driving assistance ECU 20. The warning unit 50 includes, for example, a speaker provided in the interior of the vehicle and a display unit which displays images.

The seat belt unit 60 includes seat belts provided on respective seats of the own vehicle and pretensioners which reels in the respective seat belts. When a probability that the own vehicle CS will collide with the object Ob has increased, the seat belt unit 60 performs a preliminary operation of reeling in the seat belt as PCS operation. When the collision is not avoidable, the seat belt unit 60 reels in the seat belt to eliminate deflection to secure an occupant such as the driver to the seat and protect the occupant.

The driving assistance ECU 20 is configured as a well-known microcomputer including a CPU, a ROM, and a RAM, and controls the own vehicle CS with reference to an arithmetic program, control data, and the like, in the ROM, Furthermore, the driving assistance ECU 20 detects the object Ob on the basis of the detection result from the radar sensor 32 and executes PCS control on at least one of the units 40, 50, and 60 on the basis of the detection result. When executing the PCS, the driving assistance ECU 20 functions as an object recognition section 21, a movement path calculation section 22, a collision position calculation section 23, a correction section 24, and a collision determination section 25 by executing the programs stored in the ROM.

First, the PCS executed by the driving assistance ECU 20 will be described. The object recognition section 21 obtains a position Pr of the object Ob on the basis of the object detection result of the radar sensor 32. This position Pr is recorded in history information.

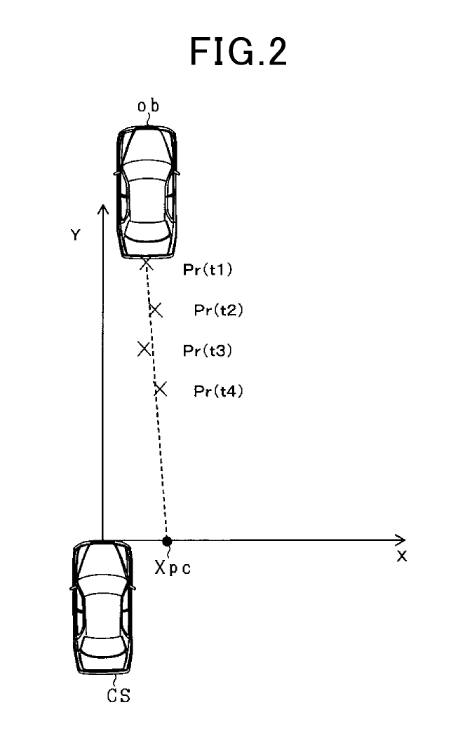

The movement path calculation section 22 calculates a movement path of the object Ob on the basis of the history information. For example, the movement path calculation section 22 calculates a movement direction vector of the object Ob as the movement path. FIG. 2 illustrates the positions Pr, at respective points in time between time t1 and time t4, of the object Ob, i.e., a preceding vehicle detected as the object Ob, and the movement path calculated from the positions Pr. The position Pr of the object Ob at time t4 is the latest position recorded in the history information. For example, the movement path calculation section 22 calculates the movement path by determining a straight line passing through the position closest to each of the positions Pr through well-known linear interpolation calculation such as the least squares method.

The collision position calculation section 23 calculates a lateral collision position Xpc on the basis of the calculated movement path. The lateral collision position Xpc is a position of the object Ob in the vehicle width direction (X axis direction) in an assumed state where the distance between the object Ob and the own vehicle CS in the Y axis direction is zero. In FIG. 2, the position at which the distance between the object Ob and the own vehicle CS in the Y axis direction is 0 is on the X axis on the coordinates, and thus the lateral collision position Xpc is calculated as a point of intersection of the movement path and the X axis.

The collision determination section 25 determines a probability of a collision between the own vehicle CS and the object Ob on the basis of the calculated lateral collision position Xpc. For example, the collision determination section 25 sets a virtual collision determination region in front of the own vehicle CS, and when the lateral collision position Xpc is within the collision determination region, determines that there is a probability that the own vehicle CS and the object Ob will collide with each other. Then, the collision determination section 25 calculates the time to collision (TTC) that is required for the object Ob determined as being likely to collide with the own vehicle CS. The collision determination section 25 executes the PCS by controlling the warning unit 50, the braking unit 40, and the seat belt unit 60 according to the TTC.

Note that the length of the collision determination region in the X axis direction is set on the basis of the vehicle width of the own vehicle CS, but may be changed according to the object type as another example. When the lateral collision position Xpc is within the collision determination region, the degree of the likelihood of a collision may be determined on the basis of the ratio between the length between the center of the own vehicle CS and the lateral collision position Xpc and the length of the collision determination region in the X axis direction.

If the lateral collision position Xpc has a deviation in the vehicle width direction due to an error of the movement path obtained by the radar sensor 32, the object Ob that is actually likely to cause a collision may be determined as not being likely to cause a collision. When a slope θ of the movement path changes according to the error of the relative position, a deviation ΔX of the lateral collision position Xpc in the vehicle width direction (X axis direction) increases, even with the same slope θ, as the relative distance Dr between the object Ob and io the own vehicle CS in the Y direction increases.

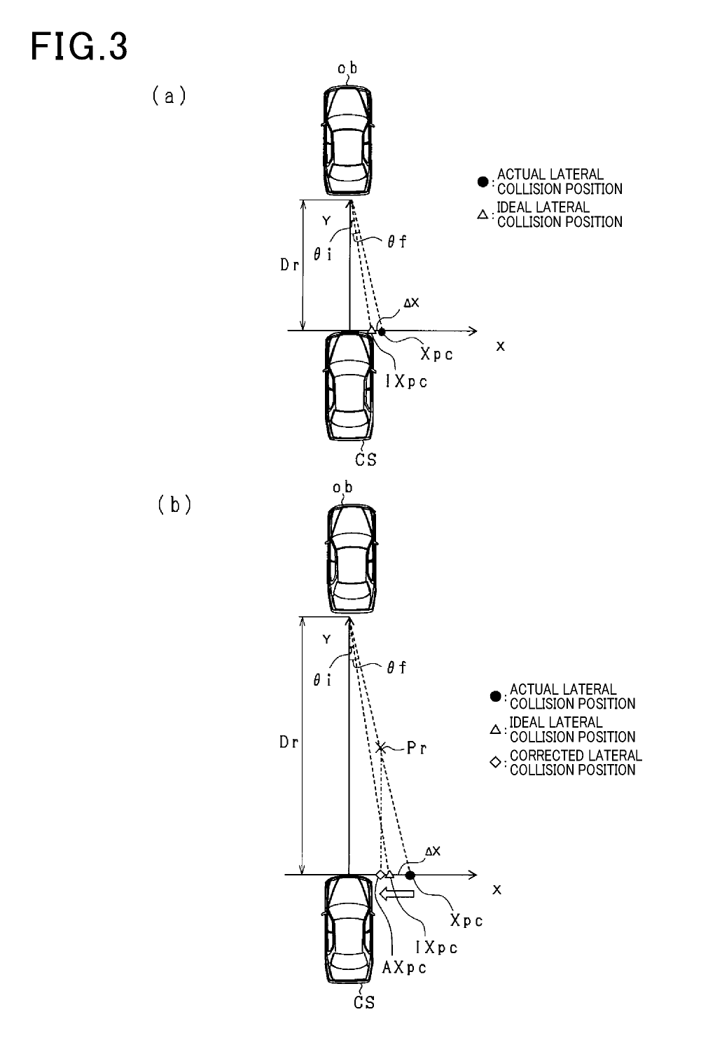

FIG. 3 illusrtates, in (a) and (b), the lateral collision positions Xpc defined by a slope θi of the ideal movement path in the case where each position Pr of the object Ob has no error, and a slope θf which has increased due to the error. First, in both of (a) and (b) in FIG. 3, the actual slope θf is greater than the ideal slope θi, and the actual lateral collision position Xpc has a deviation ΔX from the ideal lateral collision position IXpc in a direction away from the own vehicle CS. In (b) in FIG. 3, the relative distance Dr is greater than that in (a) in FIG. 3, meaning that the deviation ΔX is large.

In response, the correction section 24 corrects the calculated lateral collision position Xpc by moving the calculated lateral collision position Xpc toward the current position of the object Ob when the slope θ is small, on the assumption that the lateral collision position Xpc becomes closer to the current position of the object Ob in the vehicle width direction as the slope θ of the movement path decreases. In (b) of FIG. 3, as a result of the correction by the correction section 24, the corrected lateral collision position AXpc is made close to the position Pr of the object Ob in the X axis direction. Note that although the corrected lateral collision position AXpc is closer to the own vehicle CS than the ideal lateral collision position IXpc is in (b) in FIG. 3, this is merely one example.

Through the correction by the correction section 24, the lateral collision position Xpc is inhibited from being relatively distant from the current position of the object Ob in the vehicle width direction due to an error in the relative position, and thus the probability of a collision between the object Ob and the own vehicle CS can be properly determined.

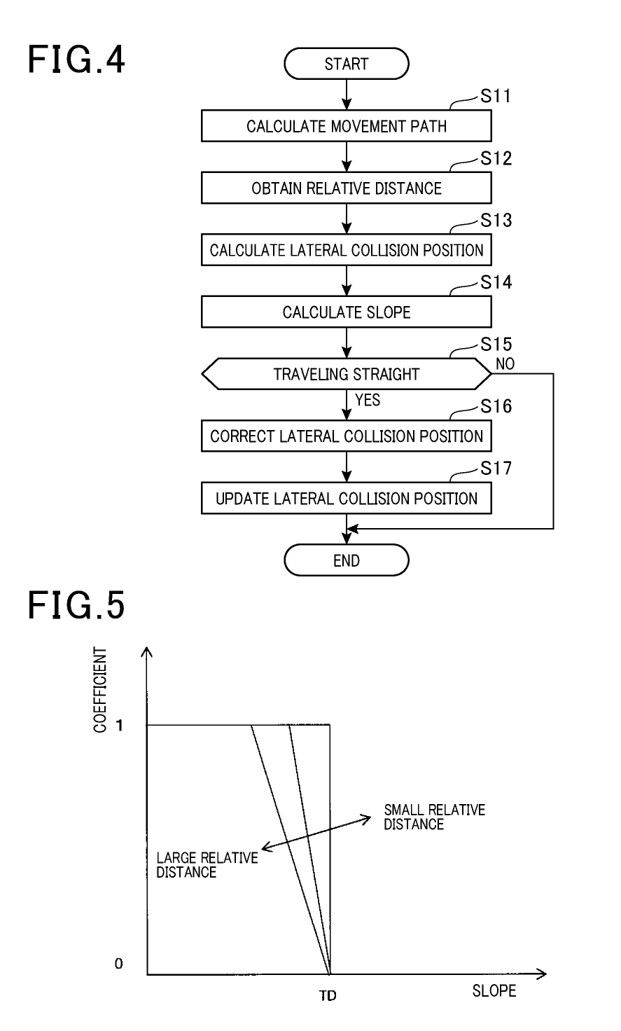

Next, a process of calculating the lateral collision position Xpc by the driving assistance ECU 20 will be described with reference to a lo flowchart in FIG. 4. The process shown in FIG. 4 is repeatedly performed by the driving assistance ECU 20 in a predetermined cycle.

In step S11, a movement path is calculated. The movement path of the object Ob is calculated on the basis of each position Pr recorded in the history information. Step S11 functions as a movement path calculation step.

In step S12, the relative distance Dr is obtained. A component, in the Y direction, of the position Pr obtained from an output of the radar sensor 32 is calculated as the relative distance Dr between the object Ob and the own vehicle CS. Thus, step S12 functions as a relative distance obtainment section.

In step S13, the lateral collision position Xpc is calculated on the basis of the movement path calculated in step S11. As shown in FIG. 2, a point of intersection of the movement path and the X axis on the relative coordinates is calculated as the lateral collision position Xpc. Step S13 functions as a collision position calculation step.

In step S14, the slope θ of the movement path with reference to the Y axis direction (own vehicle traveling direction) is calculated. For example, the slope θ is calculated on the basis of a ratio between the distance from the lateral collision position Xpc calculated in step S13 to the center of the own vehicle CS and the relative distance Dr obtained in step S12,

In step S15, whether or not the own vehicle CS is traveling straight is determined. The turning amount of the own vehicle CS is calculated on the basis of the output from the yaw rate sensor 33, and if the turning amount is a threshold value or less, the own vehicle CS is determined as traveling straight.

If the own vehicle CS is determined as not traveling straight (step S15: NO), the lateral collision position Xpc is determined as changing significantly over time, and the process shown in FIG. 4 is halted.

If the own vehicle CS is determined as traveling straight (step S15: YES), the lateral collision position Xpc calculated in step S13 is corrected in step S16. For example, the lateral collision position Xpc is corrected by using the following expression (1):

AXpc=α·Xn+(1−a)Xpc (1)

where AXpc represents the corrected lateral collision position Xpc, Xn represents the X coordinate of the object Ob at the current position, and the correction coefficient α represents how close the lateral collision position Xpc is brought to the object Ob in the X axis direction; in the present embodiment, the correction coefficient has a value between 0 and 1. Note that step S16 functions as a correction step.

In the above expression (1), when the correction coefficient α is changed in a range between 0 and 1, the corrected lateral collision position AXpc changes in a range between the current lateral collision position Xpc and the position Xn in the X axis direction. The value of the correction coefficient α is mainly set according to the slope θ.

The correction coefficient a. is obtained from a map shown in FIG. 5 by using the slope θ of the movement path calculated in step S14 and the relative distance Dr obtained in step S12. FIG. 5 shows a relationship in which the correction coefficient α is 0 when the slope θ is greater than a threshold angle TD, and the correction coefficient α has a value greater than 0 when the slope θ is less than the threshold angle TD. In other words, when the slope θ is greater than the threshold angle TD, since the correction coefficient α is 0, the corrected lateral collision position AXpc agrees with the lateral collision position Xpc. When the slope θ is less than the threshold angle TD, since the correction coefficient is greater than 0, the corrected lateral collision position AXpc is closer to the position Xn than the lateral collision position Xpc is. A situation in which the correction coefficient α is 1 io when the slope θ is less than the threshold angle TD means that the corrected lateral collision position AXpc agrees with the position Xn.

Here, the threshold angle TD defines the slope θ which is subjected to the correction by the correction section 24; in the present embodiment, the threshold angle TD is set within a range of 20 to 40 degrees with reference to the Y axis. More preferably, the threshold angle TD is set to have a value in the vicinity of 30 degrees.

Furthermore, in the map shown in FIG. 5, the value of the correction coefficient α is set to be more likely to approach 1 as the value obtained as the relative distance Dr decreases in the case where the slope θ is less than the threshold angle TD. Therefore, as the relative distance Dr obtained in step S12 decreases, the corrected lateral collision position AXpc calculated by using the correction coefficient α and the above expression (1) has a value closer to the position Xn.

In step S17, the corrected lateral collision position AXpc calculated in step S16 is updated as the current lateral collision position Xpc. Subsequently, when the process in step S17 ends, the process shown in FIG. 4 is halted.

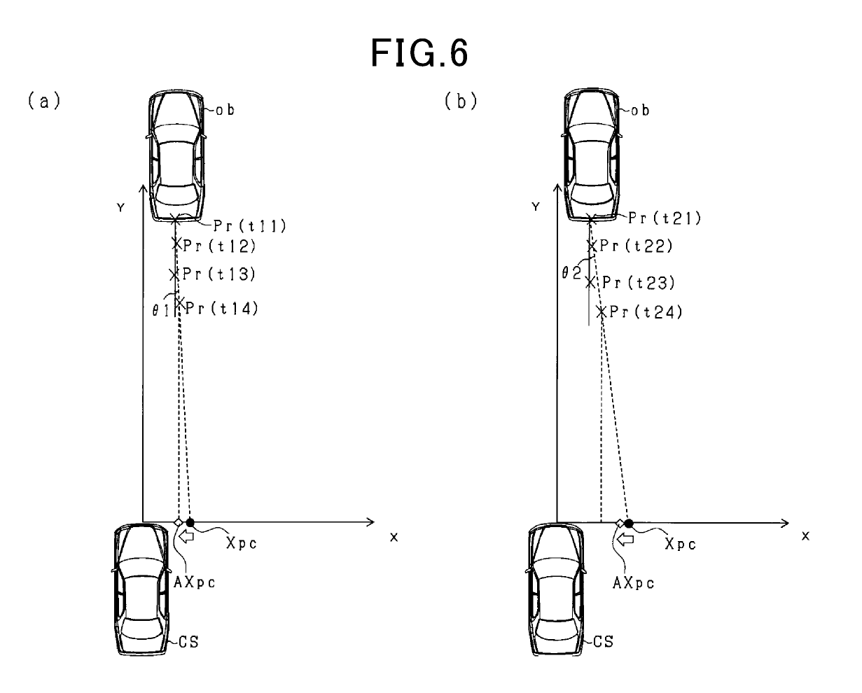

Next, the lateral collision position Xpc which is calculated in the process shown in FIG. 4 will be described. FIG. 6 shows, in (a) and (b), the positions Pr of a preceding vehicle recognized as the object Ob during periods including time til to time t14 and time t21 to time t24, and the movement path calculated by using the positions Pr. It is assumed that the lateral collision position Xpc is calculated in a position on the front of the own vehicle CS according to this movement path. The slope θ1 shown in (a) in FIG. 6 has a smaller value than the slope θ2 shown in (b) in FIG. 6.

FIG. 6 shows, in (a), correction of the lateral collision position Xpc (t14) when the own vehicle CS is at the position Pr (t14). In this case, the slope θ1 is less than the threshold angle TD, and the corrected lateral collision position AXpc is close to the X axis component (position Xn) of the current position Pr (t14) of the own vehicle CS.

FIG. 6 shows, in (b), correction of the lateral collision position Xpc (t24) when the own vehicle CS is at the position Pr (t24). In this case, the slope θ2 is the slope θ1 or more and less than the threshold angle TD, and thus the corrected lateral collision position AXpc is close to the current lateral collision position Xpc (t24). In other words, the distance from the corrected lateral collision position AXpc shown in (b) in FIG. 6 to the X axis component (position Xn) of the current position Pr (t24) of the own vehicle CS is greater than that in (a) in FIG. 6.

As described above, in the first embodiment, the driving assistance ECU 20 corrects the calculated lateral collision position Xpc so that when the slope θ of the movement path is small, the calculated lateral collision position is closer to the object Ob than when the slope θ of the movement path is large. With the aforementioned configuration, when the slope θ is small, the lateral collision position Xpc is inhibited from being relatively distant from the object Ob in the vehicle width direction due to an error in the obtained position Pr of the object, and thus the probability of a collision between the object Ob and the own vehicle CS can be properly determined.

The driving assistance ECU 20 sets, on the basis of the slope θ of the movement path, the correction coefficient α indicating how close the lateral collision position Xpc is brought to the object Ob in the vehicle width direction, and corrects the lateral collision position Xpc by using the set correction coefficient α. With the aforementioned configuration, how close the lateral collision position Xpc is brought to the object Ob can be calculated by using the correction coefficient a corresponding to the slope θ, and thus the lateral collision position Xpc can be easily corrected.

The driving assistance ECU 20 obtains the relative distance Dr between the own vehicle CS and the object Ob in the own vehicle traveling direction, and corrects the lateral collision position Xpc so that as the relative distance Dr decreases, the lateral collision position Xpc becomes closer to the object Ob. When the distance between the own vehicle CS and the object Ob is short, the lateral collision position Xpc calculated on the basis of the movement path is closer to the object Ob in the vehicle width direction than when the distance between the own vehicle CS and the object Ob is long. Therefore, the lateral collision position Xpc is corrected so that as the distance between the own vehicle Cs and the object Ob decreases, the lateral collision position Xpc becomes closer to the object Ob. With the aforementioned configuration, even when the distance between the own vehicle CS and the object Ob changes, the probability of collision between the own vehicle CS and the object Ob can be properly determined.

When the own vehicle travels in a curved path or the like, a change in the own vehicle traveling direction may cause the relative position relationship between the object Ob and the own vehicle CS to change, resulting in the lateral collision position Xpc significantly changing over time, Thus, the driving assistance ECU 20 corrects the lateral collision position Xpc when the own vehicle CS is traveling straight, which is a state in which the relative position relationship between the object Ob and the own vehicle CS does not significantly change. The aforernentioned configuration allows an increase in the accuracy of the correction of the lateral collision position Xpc.

### Second Embodiment

In the second embodiment, the driving assistance ECU 20 corrects the lateral collision position Xpc so that as a relative speed Vr of the object Ob with reference to the own vehicle CS decreases, the lateral collision position Xpc becomes closer to the object Ob. Here, the relative speed Vr with reference to the own vehicle CS means a io value obtained by subtracting an own vehicle speed Vs from the relative speed Vr of the object Ob. In the present embodiment, it is assumed that the direction in which the object Ob approaches the own vehicle CS is a positive side, and the direction in which the object Ob goes away from the own vehicle CS is a negative side.

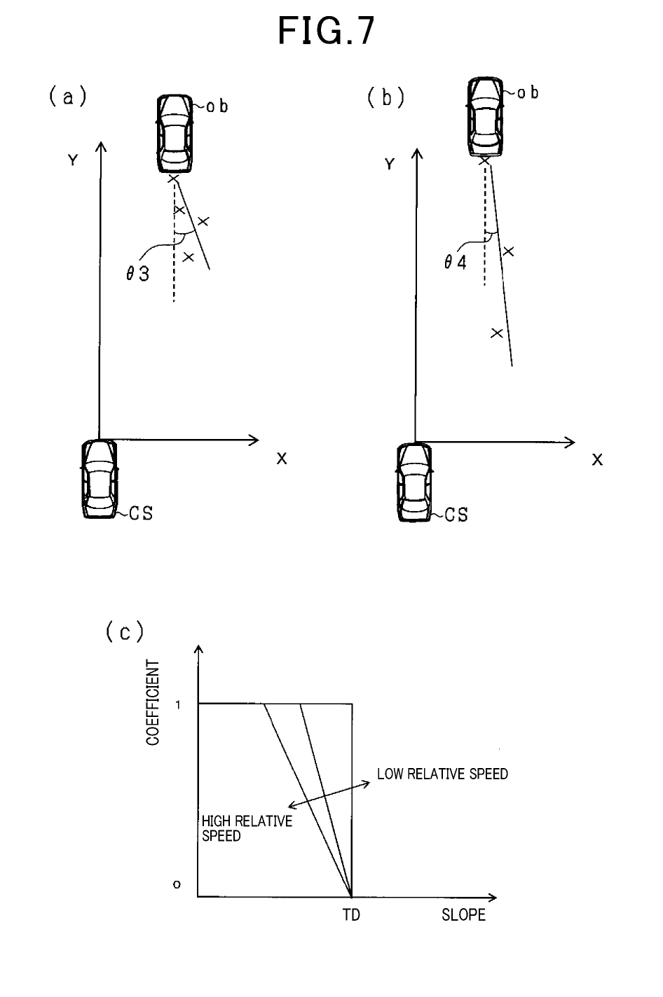

FIG. 7 shows, in (a) and (b), changes in the positions Pr of the objects Ob at different relative speeds Vr. The relative speed Vr of the object Ob shown in (a) in FIG. 7 is lower than that of the object Ob shown in (b) in FIG. 7.

The slope θ of the movement path can be represented using a ratio between a relative speed Vy of the object Ob in the own vehicle traveling direction and the relative speed Vx in the vehicle width direction. As the relative speed Vr of the object Ob decreases, the ratio of the relative speed Vy in the own vehicle traveling direction (Y axis direction) to the relative speed Vx in the vehicle width direction (X axis direction) increases. Therefore, when the obtained position Pr has an error in the vehicle width direction, the effect of this error increases as the relative speed Vr decreases. In the example in FIG. 7, the relative speed Vr of the object Ob in (a) in FIG. 7 is lower than that of the object Ob in (b) in FIG. 7, and a slope θ3 is greater than a slope θ4; it can be considered that the error in the vehicle width direction has a significant effect.

Therefore, in this second embodiment, the driving assistance ECU 20 corrects the calculated lateral collision position Xpc so that as the relative speed Vr decreases, the calculated lateral collision position Xpc becomes closer to the object Ob. For example, in step S16 in FIG. 4, the correction coefficient α is obtained on the basis of the slope θ of the movement path and the relative speed Vr of the object Ob. The value of the correction coefficient α shown in (c) in FIG. 7 is set to be more likely to approach 1 as the relative speed Vr decreases than when the relative speed Vr is high in the case where the slope θ is less than io the threshold angle TD. Therefore, when the driving assistance ECU 20 performs the process in step S16 in FIG. 4 using this correction coefficient α, the corrected lateral collision position AXpc is more likely to approach the current X-coordinate position Xn of the object Ob as the relative speed Vr decreases.

Note that the driving assistance ECU 20 calculates the relative speed Vr of the object Ob by dividing the relative distance Dr obtained in step S12 in FIG. 4 by a predetermined time. The predetermined time can be, for example, the time period from when the radar sensor 32 transmits transmission waves to when reflected waves corresponding to the transmission waves are received. Therefore, in the second embodiment, the driving assistance ECU 20 functions as a relative speed obtainment section. Note that when the radar sensor 32 can therein calculate the relative speed, the driving assistance ECU 20 may directly obtain the relative speed Vr from the output of the radar sensor 32.

As described above, in this second embodiment, the driving assistance ECU 20 corrects the lateral collision position Xpc so that as the relative speed Vr decreases, the lateral collision position Xpc becomes closer to the object Ob. With the aforementioned configuration, even when the relative speed Vr of the object Ob changes, the probability of a collision between the object Ob and the own vehicle CS can be properly determined.

### Third Embodiment

In the third embodiment, the driving assistance ECU 20 modifies the correction amount of the lateral collision position Xpc according to the object type.

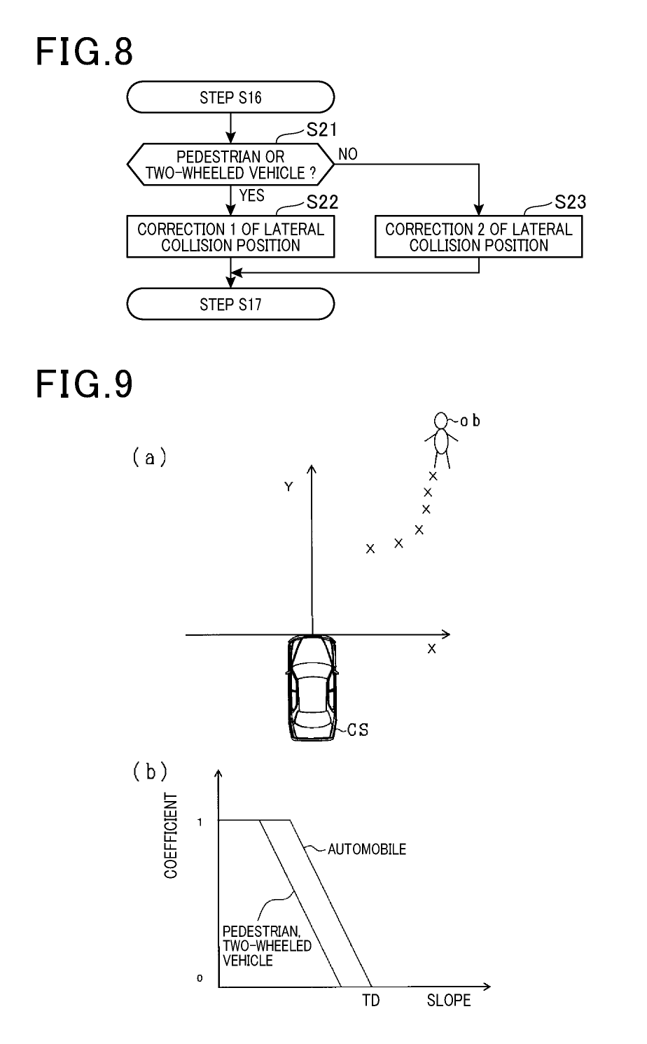

In the third embodiment, a process which the driving assistance ECU 20 performs in step S16 in FIG. 4 will be described with reference to FIG. 8. First, in step S21, the object type is determined. The object io type is determined on the basis of type determination information output from the camera sensor 31. In the third embodiment, the object type is determined as one of a pedestrian, a two-wheeled vehicle, and an automobile according to the type determination information. Here, the two-wheeled vehicle includes a bicycle and a two-wheeled saddle motor vehicle, for example. Step S21 functions as a type determination section.

If the object type is a two-wheeled vehicle or a pedestrian (step S21: YES), the lateral collision position Xpc is corrected in a manner corresponding to the two-wheeled vehicle or the pedestrian (correction 1 of the lateral collision position) in step S22. On the other hand, if the object type is an automobile (step S21: NO), the lateral collision position Xpc is corrected in a manner corresponding to the automobile (correction 2 of the lateral collision position) in step S23.

As shown in (a) in FIG. 9, a pedestrian and a two-wheeled vehicle are more likely to make sudden lateral movement than an automobile, and the movement path may suddenly change from the own vehicle traveling direction (Y-axis direction) to the vehicle width direction (X-axis direction). Since a sudden change in the movement path causes the lateral collision position Xpc to change significantly, the lateral collision position Xpc is not corrected significantly depending on the object type that may cause the lateral collision position Xpc to change significantly.

FIG. 9 shows, in (b), the correction coefficient α for two-wheeled vehicles or pedestrians and the correction coefficient α for automobiles. The value of the correction coefficient α for two-wheeled vehicles or pedestrians is set to be less likely to approach 1 than the correction coefficient α for automobiles in the state where the slope θ is the same when the slope θ is less than the threshold angle TD. In other words, the corrected lateral collision position AXpc calculated using the correction coefficient α for two-wheeled vehicles or pedestrians is io closer to the current lateral collision position Xpc than the corrected lateral collision position AXpc calculated using the correction coefficient a for automobiles.

Although the same correction coefficient α is used for two-wheeled vehicles and pedestrians in the present embodiment, different correction coefficients a may be applied to two-wheeled vehicles and pedestrians. In this case, for example, the wobble frequency of a two-wheeled vehicle when traveling straight is higher than that of a pedestrian, and thus the correction coefficient α for two-wheeled vehicles is set to a value that is less likely to approach 1 than the correction coefficient α for pedestrians.

As described above, in this third embodiment, the driving assistance ECU 20 determines the object Ob as one of at least a pedestrian, a two-wheeled vehicle, and an automobile. Subsequently, when the object Ob is a pedestrian or a two-wheeled vehicle, the driving assistance ECU 20 corrects the lateral collision position Xpc so that the corrected lateral collision position Xpc is closer to the lateral collision position Xpc in the vehicle width direction than when the object Ob is an automobile. With the aforementioned configuration, the correction amount is not set high for pedestrians and two-wheeled vehicles, the movement direction of which is likely to change abruptly, and thus the probability of a collision with the own vehicle CS can be properly determined.

### Other Embodiments

The driving assistance ECU 20 may be configured to obtain the correction coefficient α by a combination of the slope θ, the object type, and the relative distance. In this case, the driving assistance ECU 20 stores a map in which the slope θ, the object type, and the relative distance Dr are input values and the correction coefficient α is an output value, and obtains the correction coefficient α by using the map. Alternatively, the driving assistance ECU 20 may be configured to io obtain the correction coefficient α by a combination of the slope θ, the object type, and the relative speed Vr.

Instead of the relationship in which the correction coefficient α is non-linear with respect to the slope θ, the relationship in which the correction coefficient α is linear with respect to the slope θ may be used.

In this case, the correction coefficient α monotonically increases between 0 and 1 as the slope θ increases. Furthermore, in the case of using the relationship in which the correction coefficient α is linear with respect to the slope θ, the driving assistance ECU 20 may be configured to calculate the correction coefficient α from the slope θ through arithmetic processing instead of using the map defining the relationship between the slope θ and the correction coefficient α.

The driving assistance ECU 20 may be configured to detect the position Pr of the object Ob by using the camera sensor 31 instead of detecting the position Pr of the object Ob by using the radar sensor

The object recognition section 21 may be configured to detect the position Pr of the object Ob by using a first position indicating the object detection result of the radar sensor 32 and a second position indicating the object detection result of the camera sensor 31. Specifically, when there is an area of overlap between a radar search region which is set on the basis of the first position and an image search region which is set on the basis of the second position, it is determined that the same object Ob has been detected. The state in which the position Pr of the object Ob is successfully obtained using the radar sensor 32 and the camera sensor 31 is referred to as a fusion state. The driving assistance ECU 20 uses, as the position Pr of the object Ob, the position of the object Ob determined as being in the fusion state.

Instead of the movement direction vector of the object Ob, a path resulting from curve interpolation of the positions Pr recorded in the history information may be used as the movement path.

The slope θ of the movement path may be calculated using the ratio between the relative speed Vx of the object Ob in the X axis direction and the relative speed Vy of the object Ob in the Y axis direction. In this case, in step S14, the driving assistance ECU 20 calculates the slope θ by using the relative speed Vx in the X axis direction and the relative speed Vy in the Y axis direction.

The PCSS 100 may be configured to include the driving assistance ECU 20 and the camera sensor 31 as a single unit instead of including the driving assistance ECU 20 and the camera sensor 31 separately. In this case, for example, the above-described driving assistance ECU 20 is included inside the camera sensor 31.

In step 515 in FIG. 4, instead of the method in which information from the yaw rate sensor 33 is used to determine whether or not the own vehicle CS is traveling straight, the steering amount of the own vehicle CS may be used to determine whether or not the own vehicle CS is traveling straight. In this case, the driving assistance ECU 20 includes a steering amount sensor which detects the steering amount of a steering unit, which is not shown in the drawings. In step S15, whether or not the own vehicle CS is traveling straight is determined on the basis of the output from this steering amount sensor.

The present disclosure has been described in accordance with the embodiments, but the present disclosure should in no way be construed as being limited to the embodiments and described configurations. The present disclosure encompasses various modified examples and modifications made within the range of equivalence. In addition, various combinations and forms, and furthermore, other combinations and forms including only one element of these or elements no less than or no more than these are also included in the scope or the spirit of the present disclosure.

1. A vehicle control apparatus which determines a probability of a collision between an own vehicle and an object and controls the own vehicle based on a determination result, the vehicle control apparatus comprising:
a movement path calculation section which calculates a movement path of the object based on a position history of the object around the own vehicle;
a collision position calculation section which calculates a lateral collision position based on the movement path calculated, the lateral collision position being a position of the object in a vehicle width direction in an assumed state where a distance between the object and the own vehicle is zero; and
a correction section which corrects the lateral collision position so that when the movement path has a small slope with reference to an own vehicle traveling direction, the lateral collision position is closer to the object in the vehicle width direction than when the slope is large.

2. The vehicle control apparatus according to claim 1, wherein
the correction section sets a correction coefficient based on the slope and corrects the lateral collision position by using the correction coefficient that has been set, the correction coefficient indicating how close the lateral collision position is brought to the object.

3. The vehicle control apparatus according to claim 1, further comprising a distance obtainment section which obtains a distance between the own vehicle and the object in the own vehicle traveling direction, wherein
the correction section corrects the lateral collision position so that as the distance obtained by the distance obtainment section decreases, the lateral collision position becomes closer to the object.

4. The vehicle control apparatus according to claim 1, further comprising a relative speed obtainment section which obtains a relative speed of the object with reference to the own vehicle, wherein
the correction section corrects the lateral collision position so that as the relative speed decreases, the lateral collision position becomes closer to the object.

5. The vehicle control apparatus according to claim 1, further comprising a type determination section which determines the object as one of at least a pedestrian, a two-wheeled vehicle, and an automobile, wherein
the correction section corrects the lateral collision position so that when the object is the pedestrian or the two-wheeled vehicle, the corrected lateral collision position is closer to the lateral collision position in the vehicle width direction than when the object is the automobile.

6. The vehicle control apparatus according to claim 1, wherein
the correction section corrects the lateral collision position when the own vehicle is traveling straight.

7. A vehicle control method of determining a probability of a collision between an own vehicle and an object and controlling the own vehicle based on a determination result, the vehicle control method comprising:
a movement path calculation step of calculating a movement path of the object based on a position history of the object around the own vehicle;
a collision position calculation step of calculating a lateral collision position based on the movement path calculated, the lateral collision position being a position of the object in a vehicle width direction in an assumed state where a distance between the object and the own vehicle is zero; and
a correction step of correcting the lateral collision position so that when the movement path has a small slope with reference to an own vehicle traveling direction, the lateral collision position is closer to the object in the vehicle width direction than when the slope is large.
